(19) United States
(12) Patent Application Publication
(10) Pub. No.: US 2007/0185792 A1
(43) Pub. Date: Aug. 9, 2007

(54) Method and system for assisting in compiling employee tax deduction

(75) Inventors: Sudhindra Naib, Bangalore (IN); Suraj Sudhi, Kerala (IN)

Correspondence Address: KENYON & KENYON LLP, 1500 K STREET N.W., WASHINGTON, DC, 20005, US

(73) Assignee: SAP

(21) Appl. No.: 11/351,012

(22) Filed: Feb. 9, 2006

(51) Int. Cl. G07F 19/00

(52) U.S. Cl. 705/31

(57) ABSTRACT

A method for use by a payroll department for facilitating computing tax deductions of employees in their pay-checks, uses a tax workbench (and UI) which facilitates SAP or other software in carrying out the tax computation process to completion. The method may be incorporated into an existing SAP system known as R/3 which may be an ERP (enterprise resource planning) system. A user logs on to a single O/S and ensures that a Tax Update Bulletin (TUB) supplied by a service provider and incorporated into the O/S is up to date. Thereafter, the user completes steps in a predetermined sequence selectively either manually or automatically. The method saves user-time in completing the step sequence and eliminates the degree of dependence on the SAP system for importing TUBs, and obviates the need for a high level of user expertise and the need for accessing multiple operating systems.

### FIELD OF THE INVENTION

This invention generally relates to the field of software automation, and more specifically to a method and apparatus to provide structure and automation to gathering and specifying requirements for enterprise software and for performing software engineering, release and management automation for the generation of the enterprise software.

### BACKGROUND OF THE INVENTION

Many businesses and companies in the United States and elsewhere use software information provided by a provider such as BSI® (Business Software, Inc). Tax calculation in several companies is done by using software provided by providers such as SAP® (Systeme, Anwendungen, Produkte), by using tax update information provided by providers such as BSI. The tax updates are usually made available by providers such as BSI in the form of Tax Update Bulletins received by an SAP service provider in different regions on a regular basis. The tax changes need o be incorporated into payroll execution tools by the user companies. The process of importing the tax changes in the tax update process has hitherto been done partly by SAP and partly at the customer end. At the SAP end, the process has involved accessing, logging on to changing data in different releases of the tax computing process and utilizing non-SAP tools including those provided by BSI in specific order, and manually logging and completing incorporation of the data changes.

Problems have been encountered in the hitherto known tax computing process, relating to issues such as authorization, data inconsistency, time- consumption, operator-errors (both oversight and knowledge-level related). Consequently, users have preferred SAP to complete the major portion of the process, and ship the information to customers in the form of SAP archive files and different releases.

At the customer's end, the multiplicity and data changes in the SAR files has usually led too further complications as firstly, the customer needed to access the Service Market Place (SMP) for obtaining the SAR files, and the customer has had no control over the availability of the files and could monitor the SMP only intermittently. Furthermore, importing the SAR files from the SMP required additional technical knowledge and an expert's involvement at the customer's end.

One of the major drawbacks in the prior art tax computing processes as known was that there was no tracking or enforcement of the different steps involved. Steps were sometimes executed repetitively thereby creating data inconsistencies. Thus, known tax computing processes using the forgoing approach were error prone. Additionally, known tax computing processes required the user to interact with multiple user interfaces for multiple systems and required a wide spectrum of technical capabilities. Also, known tax computing processes have required that the user should be physically present at the site where the primary server is located. There is thus a need for a tax computing process which addresses the forgoing drawbacks in know tax computing processes.

### SUMMARY OF THE INVENTION

The present invention generally assists in facilitating pay roll departments of companies in computing taxes for employees, and is directed to a simplified method of using tax-update information from predetermined sources in assisting tax calculations. The invention teaches a method for use by a payroll department for facilitating computing tax deductions of employees in their pay checks, by using a tax workbench which offers higher efficiency and advantages over known method of computing tax. The invention may be incorporated in an existing SAP system known as R/3 which may be an ERP (enterprise resource planning) system. The invention as taught herein assists the user in following a uniform yet customizable process for carrying out the tax updates. A logical sequence of events is enforced, and implementation of the tax update information and resolution is made easier. The inventive tax workbench of this invention provides a tool which is user-friendly and intuitive and enables a user to use an appropriate single operating system (which in the illustrations is shown as an R/3 system that is specific to SAP users), to access multiple systems including the SAP source which the user would be interacting with in the background. The tool requires very little user-expertise and requires less human intervention after being invoked, as compared to prior art approaches. Also, since the invention can be incorporated within an existing user system such as the R/3, updates in the process can be invoked remotely, eliminating geographical barriers. Once the inventive operating system is shipped for use, the system will facilitate SAP or other software to carry out the tax computation process to completion. Thus the customer is not impeded by the limitations of the SAP schedules for receiving support, thus saving time.

The invention in one form resides in a method for use by a payroll department for updating tax information for facilitating tax deductions of employees in their paychecks, comprising the steps of: an operator logging on to a single operating system; automatically receiving latest tax compilation guidelines from a predetermined tax-information source and entering the guidelines in the tax workbench; ensuring from a display on a UI (user interface) screen of the operating system that the tax compilation guidelines are updated and are applicable; following a step sequence of steps displayed on said Ul screen; and, completing implementation of said guidelines for use by the payroll department in a single log-in operation by the user. Preferably, the display on the UI is configured to prompt the user to make the decision as to whether to continue or not with level of update available with the tax compilation guidelines. The step sequence comprises intuitive and easy steps. The steps in the step sequence can be tailored to suit the needs of different users. The method provides the user the option to execute selected steps in a simulation mode to enable the user to view the probable actions of the implementation of the selected steps.

The invention in another form resides in a method for use by a payroll department for facilitating computing tax deductions from employees in a payroll listing, using SAP (Systeme, Anwendungen, Produkte) software assistance, comprising the steps of: an operator logging on to a single operating system (O/S) using a user interface (UI); automatically receiving tax-compilation bulletins from a predetermined tax information source and entering the bulletins in the workbench; the operator choosing required ones of said bulletins and other information on said UI; the operator following a step sequence displayed on said UI; and, completing implementation of chosen tax compilation bulletin/s and said other information in a single log in operation by the user.

The process of the invention provides one of more of the following advantages: Independence from any delivery schedules of the service provider such as SAP; a streamlined tax deduction computation process rather than en error prone collection of disjoint steps; availability to view progress tracking on the UI; the simplicity of using a single UI and completing the process with a single log-on operation; lack of need on the part of the user to have expert knowledge; time saving; and provision for error tracking and display which is easy to understand.

### BRIEF DESCRIPTION OF THE DRAWING

Brief Description of the Drawing: A more detailed understanding of the invention may be had from the following description of certain embodiments, given by way of example and to be understood in conjunction with the accompanying drawing in which:

FIG. 1 is an illustration of a prior art tax computation process showing the SAP developer and the SAP customer;

FIG. 2 is an illustration of the new tax computation process showing the SAP customer and his interaction with the customer's operating system and the tax update bulletin provider such as BSI® (Business Software Inc.);

FIG. 3 is an exemplary flowchart of the proposed tax workbench method; and,

FIG. 4 is a general purpose computing platform which may be used in the practice of this invention.

### DETAILED DESCRIPTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

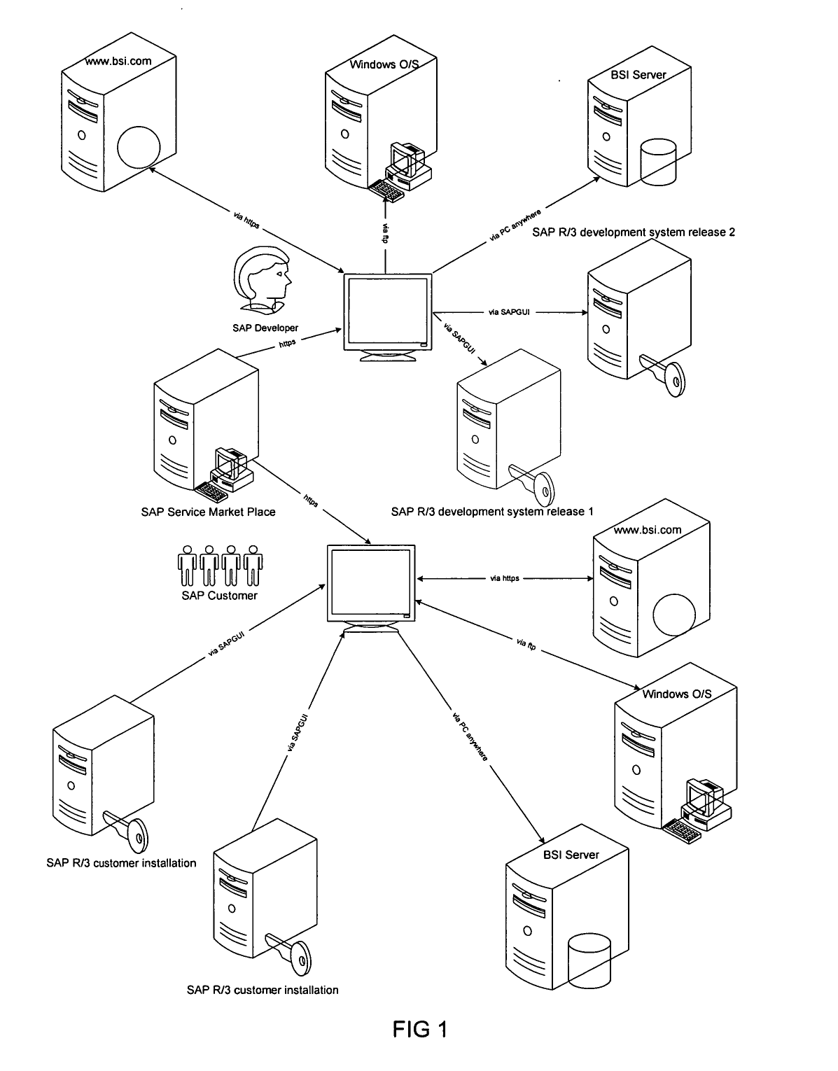

FIG. 1 illustrates a prior art arrangement of a typical interaction among an SAP developer/provider having a two way communication with a TUB (tax update bulletin) provider such as BSI (Business Software, Inc). The SAP developer is also shown in FIG. 1 as connected to an O/S (operating System) such as the R/3 of the SAP, and other systems. An SAP customer is connected to the SAP developer, as shown, through the SAP service market place. The SAP customer has to depend on the SAP service market place contact for receiving the TUB updates. The SAP customer provides necessary information to one of more of the O/Ss shown and identified as SAP R/3 installation. It is noted that the prior art illustration in FIG. 1 has the setbacks and flaws explained earlier hereinabove.

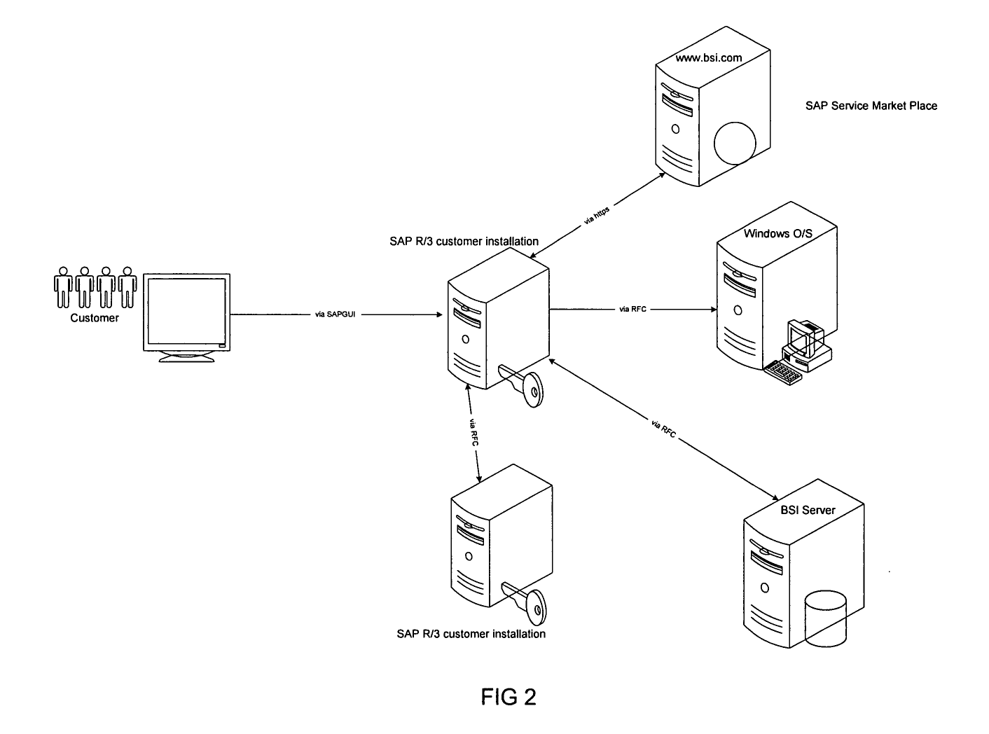

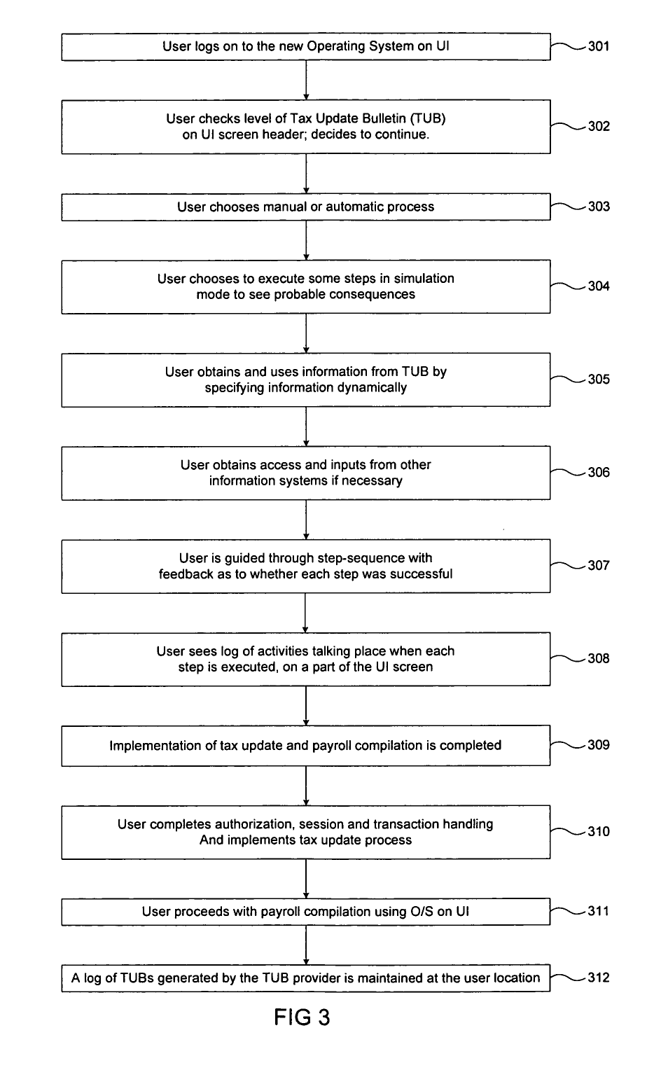

FIG. 2 illustrates an exemplary schematic which can be used in the practice of the present invention. As, shown, the customer interacts with a single O/S which may be a SAP R/3 customer installation. The SAP R/3 installation, as shown is in two way communication with a BSI server, and other O/Ss as illustrated, only by way of example. By the use of the schematic illustrated in FIG. 2, and following the sequence of steps shown in the flow chart of FIG. 3, the user is enabled to accomplish completing a tax updating process resulting in efficiency and the use of the latest TUB update automatically.

With specific reference to FIG. 3, the following are the sequence steps in an exemplary embodiment of the inventive process. It is to be understood that the steps in the step sequence may be modified and tailored to cater the specific requirements and needs of the user, and the steps illustrated in the flow chart of FIG. 3 are only by way of example and not limitation.

At the start of the process, the user logs on to the new O/S on UI, at step 301 and selectively completes the steps in the sequence below:
User checks level of Tax Update Bulletin (TUB) on UI screen header; decides to continue, at step 302;
User chooses manual or automatic process, at step 303;
User chooses to execute some steps in simulation mode to see probable consequences, at step 304;
User obtains and uses information from TUB by specifying information dynamically, at step 305;
User obtains access and inputs from other information systems if necessary, at step 306;
User is guided through step-sequence with feedback as to whether each step was successful, at step 307;
User sees log of activities taking place when each step is executed, on a part of the UI screen, at step 308;
User implements tax update and proceeds with tax computation, at step 309;
User completes authorization, session and transaction handling, and implements tax update process, at step 310;
User proceeds with payroll compilation using O/S on UI, at step 311;
A log of TUBs generated by the TUB-provider is maintained at the user location, at step 312.

Some of the advantages realized by the use of the inventive process include the following:
1. Only one R/3 system or a known alternative system needs to be logged onto as compared to multiple systems in the prior art arrangement. Other system logons are taken care of automatically as and when required.
2. The User interface and experience level needed can remain the same in spite of the fact that in the background many systems are being accessed.
3. The User need not know the nuances of all the systems that are accessed. Some of the steps in the step sequence might involve interacting with any chosen Operating System, whichever it might be. The user need not be familiar with different O/Ss if he uses the new tax update process as he only sees the standard R/3 operating system or other chosen O/S on the UI screen.
4. The customer's dependence on SAP for the delivery of these TUB changes is eliminated. As soon as the TUB provider such as BSI puts up these changes on its website, customers can immediately use this workbench to get these changes into their systems. Earlier SAP approaches had to get these changes into their systems deliberately, and then after a time lag (depending on availability of resources) release changes that the customers could import into their systems.
5. Another offshoot of the above point no 4 is that normal R/3 users can carry out the tax update process because of this workbench and not depend on system administrators or other technical people.
6. The tax update process could happen remotely via URLs in a browser as well. This is possible because of the fact that only the R/3 system needs to be logged on to and R/3 offers the possibility to web-enable R/3 screens.
7. All inherent benefits of using R/3 are passed on to the tax update process including authorization, session and transaction handling.
8. Process monitoring and error logging is possible as well as maintaining an audit trail.
9. Process automation: As only one system needs to be logged on to and as user interaction has been removed for intermediate steps, process automation can be achieved after a certain stage. This is also due to the fact that the whole process has been designed for step by step execution and includes checks to prevent parallel execution.
10. In terms of time required to carry out the steps, the new process is faster as intermediate administrative steps will happen implicitly (for example system log on, process tracking and logging). In fact in internal usage of the tool, time-statistics have shown that what used to take 1.5 person days earlier per change released by BSI, takes about an hour with the implementation of the new process.

The tax computation system taught herein can be modified additionally as follows:
1. Additional R/3 systems in the landscape can be added with some code changes. Possibility to use SAP XI to communicate with other systems including non R/3 systems can be exploited.
2. Presently, one embodiment of this process has been presented for easy use in the United States. However, it is envisaged that the generic form of the process would work for SAP HR customers in all countries (that have outsourced tax calculation to third parties).

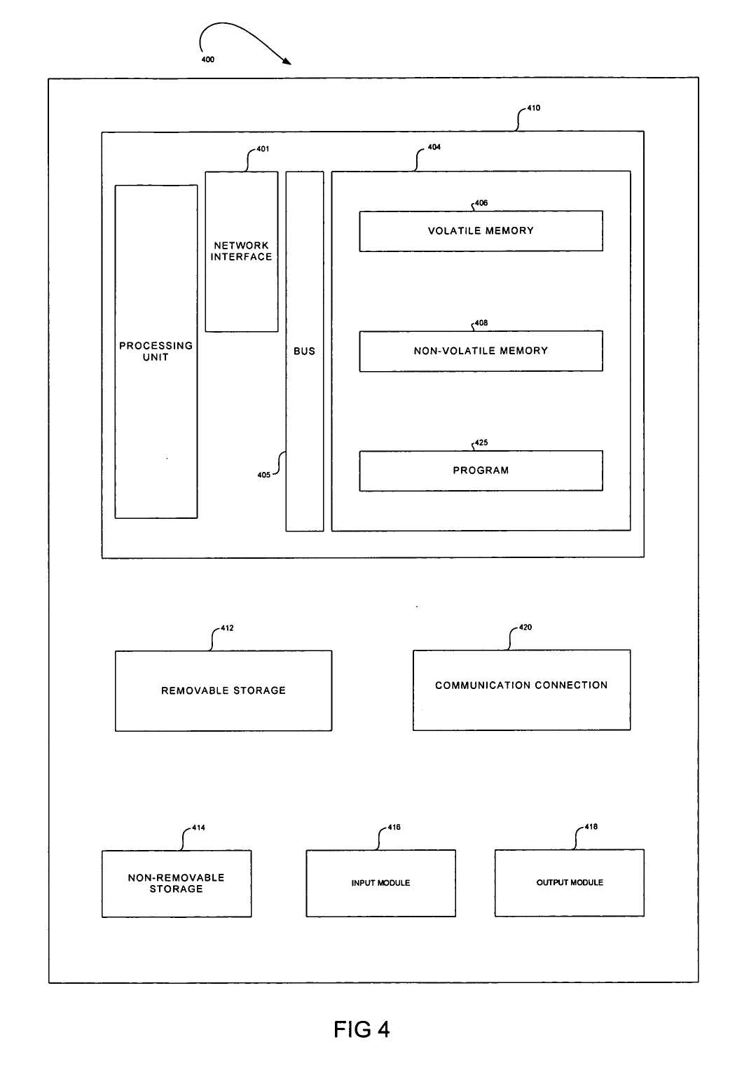

Various embodiments of the present subject matter can be implemented in software, which may be run in the environment shown in FIG. 4 or in any other suitable computing environment. The embodiments of the present subject matter are operable in a number of general-purpose or special-purpose computing environments. Some computing environments include personal computers, general-purpose computers, server computers, hand-held devices (including, but not limited to, telephones and personal digital assistants (PDAs of all types)), laptop devices, multi-processors, microprocessors, set-top boxes, programmable consumer electronics, network computers, minicomputers, mainframe computers, distributed computing environments and the like to execute code stored on a computer-readable medium. It is also noted that the embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

FIG. 4 shows an example of a suitable computing system environment for implementing embodiments of the present subject matter. FIG. 4 and the following discussion are intended to provide a brief general description of a suitable computing environment in which certain embodiments of the inventive concepts contained herein may be implemented.

With further reference to FIG. 4, a general computing device in the form of a computer 410 may include a processing unit 402, memory 404, removable storage 412, and non-removable storage 414. Computer 410 additionally includes a bus 405 and a network interface (NI) 401. Computer 410 may include or have access to a computing environment that includes one or more user input devices 416, one or more output modules or devices 418, and one or more communication connections 420 such as a network interface card or a USB connection. The one or more user input devices 416 can be a touch screen and a stylus and the like. The one or more output devices 418 can be a display device of computer, computer monitor, TV screen, plasma display, LCD display, display on a touch screen, display on an electronic tablet, and the like. The computer 410 may operate in a networked environment using the communication connection 420 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 404 may include volatile memory 406 and non-volatile memory 408. A variety of computer-readable media may be stored in and accessed from the memory elements of computer 410, such as volatile memory 406 and non-volatile memory 408, removable storage 412 and non-removable storage 414. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like, chemical storage, biological storage, and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 402 of the computer 410. For example, a computer program 425 may include machine-readable instructions capable of executing the steps illustrated in FIG. 3 selectively, to assist an HR department in the compilation of employee taxes, by taking into consideration updated BSI TUBs and all other necessary parameters. In one embodiment, the computer program 425 may be included on a CD-ROM and loaded from the CD-ROM to a hard drive in non-volatile memory 408. The machine-readable instructions cause the computer 410 to decode according to the various embodiments of the present subject matter.

It is to be understood that the above-description is intended to be illustrative, and not restrictive. For instance, the service provider supplying the TUBs could be any source other than BSI, and, the software process may be provided by a service other than SAP. The O/S might be R/3 as related to the SAP process, or any other convenient O/S. The UI may comprise one or more screens as necessary. Many other embodiments within the ambit of the invention will be apparent to those skilled in the art upon reviewing the above-description. The scope of the subject matter of the present invention should therefore be determined with reference to the following claims, along with the full scope of equivalents to which such claims are entitled.

1. A tax workbench method for use by a payroll department for updating tax information for facilitating tax deductions of employees in their paychecks, comprising the steps of:
an operator logging on to a single operating system;
automatically receiving latest tax compilation guidelines from a predetermined tax-information source and entering the guidelines in the tax workbench;
ensuring from a display on a UI (user interface) screen of the operating system that the tax compilation guidelines are updated and are applicable;
following a step sequence of steps displayed on said UI screen; and,
completing implementation of said guidelines for use by the payroll department in a single log-in operation by the user.

2. The method as in claim 1, including the step of displaying any error occurring in any of the steps is said step sequence.

3. The method of claim 1, including the step of tracking progress in the implementation of said guidelines.

4. The method as in claim 3 including the step of error tracking on said UI screen in the implementation of said guidelines.

5. The method as in claim 4, wherein the step of ensuring includes the sub-steps of locating and identifying changes in said latest tax compilation guidelines from a previous version.

6. The method as in claim 1, including the step of enabling a user to execute selected ones of said steps in said step sequence in a simulation mode to enable the user to view probable consequences.

7. The method as in claim 1, including the step of displaying actions caused by each step in said step sequence.

8. The method as in claim 1, including maintaining a log of actions taken at each site of using the method within an organization.

9. The method as in claim 1, including the step of preventing parallel execution of any of the steps in the step sequence.

10. The method as in claim 1, further selectively including the steps of authorization session handling and transaction handling.

11. The method as in claim 1, wherein said step sequence is tailored to suit needs of the payroll department.

12. The method as in claim 11, wherein said steps in the step sequence are completed manually.

13. The method as in claim 11, wherein said steps in the step sequence are completed automatically at a time specified on the UI screen.

14. The method as in claim 1, including the step of maintaining a log of Tax Update Bulletins (TUBs) received by the user in the tax workbench.

15. The method as in 1, including the step of selectively and dynamically specifying, accessing and obtaining inputs from a tax information source other than said predetermined tax information source.

16. An incometax workbench method for use by a payroll department for facilitating computing tax deductions from employees in a payroll listing, using SAP (Systeme, Anwendungen, Produkte) software assistance, comprising the steps of:
an operator logging on to a single operating system (O/S) using a user interface (UI);
automatically receiving tax-compilation bulletins from a predetermined tax information source and entering the bulletins in the workbench;
the operator choosing required ones of said bulletins and other information on said UI;
the operator following a step sequence displayed on said UI; and,
completing implementation of chosen tax compilation bulletin/s and said other information in a single log-on operation by the user.

17. The method as in claim 16, including the step of displaying any error occurring in any of the steps is said step sequence.

18. The method as in claim 16, including the step of tracking progress in the implementation of said guidelines.

19. The method as in claim 18, including the step of error tracking on said UI screen in the implementation of said guidelines.

20. The method as in claim 16, including maintaining a log of actions taken at each site that uses the method within an organization.

21. The method as in claim 16, including the step of displaying actions caused by each step in said step sequence.

22. The method as in claim 16, including maintaining a log of actions taken at each site that uses the method within an organization.

23. The method as in claim 16, including the step of preventing parallel execution of any of the steps in the step sequence.

24. The method as in claim 16, further selectively including the steps of authorization session handling and transaction handling.

25. The method as in claim 16, wherein said step sequence is tailored to suit needs of the payroll department.

26. The method as in claim 25, wherein said steps in the step sequence are completed manually.

27. The method as in claim 25, wherein said steps in the step sequence are completed automatically at a time specified on the UI screen.

28. The method as in claim 16, including the step of maintaining a log of tax updates bulletins received by the user in the tax workbench.

29. The method as in 16, including the step of selectively and dynamically specifying, accessing and obtaining inputs from a tax information source other than said predetermined tax information source.

30. An article comprising a storage medium having instructions thereon which when executed by a computing platform will result in execution of a method for use by a payroll department for updating tax information for facilitating tax deductions of employees in their paychecks, comprising the steps of:
an operator logging on to a single operating system;
automatically receiving latest tax compilation guidelines from a predetermined tax-information source and entering the guidelines in the tax workbench;
ensuring from a display on a UI (user interface) screen of the operating system that the tax compilation guidelines are updated and are applicable;
following a step sequence of steps displayed on said UI screen; and,
completing implementation of said guidelines for use by the payroll department in a single log-in operation by the user.

31. An article comprising a storage medium having instructions thereon which when executed by a computing platform will result in execution of a method for use by a payroll department for facilitating computing tax deductions from employees in a payroll listing, using SAP (Systeme, Anwendungen, Produkte) software assistance, comprising the steps of:
an operator logging on to a single operating system (O/S) using a user interface (UI);
automatically receiving tax-compilation bulletins from a predetermined tax information source and entering the bulletins in the workbench;
the operator choosing required ones of said bulletins and other information on said UI;
the operator following a step sequence displayed on said UI; and,
completing implementation of chosen tax compilation bulletin/s and said other information in a single log in operation by the user.
